(19) United States
(12) Patent Application Publication
(10) Pub. No.: US 2019/0276074 A1
(43) Pub. Date: Sep. 12, 2019

(54) APPARATUS AND METHODS TO ADJUST FOR STEERING KICKBACK

(71) Applicant: Ford Global Technologies, LLC, Dearborn, MI (US)

(72) Inventors: Garrett Tietz, Canton, MI (US); Oliver Nehls, Dusseldorf (DE); Sergio Codonesu, Aachen (DE); Timothy Cannon, Millington, MI (US); Cornelius MacFarland, Garden City, MI (US)

(21) Appl. No.: 15/913,267

(22) Filed: Mar. 6, 2018

(51) Int. Cl. B62D 6/00; B62D 5/00

(52) U.S. Cl. CPC B62D 6/008; B62D 5/006

(57) ABSTRACT

Apparatus and methods are disclosed that adjust for steering kickback. A disclosed example apparatus includes a vehicle controller configured to control a torque of a motor operatively coupled to a steering wheel based on detected driver input. The vehicle controller is also configured to adjust the torque of the motor to vary an amount of steering kickback transferred to the steering wheel.

### FIELD OF THE DISCLOSURE

This disclosure relates generally to vehicles and, more particularly, to apparatus and methods to adjust for steering kickback.

### BACKGROUND

A vehicle may include an active steering system to modify user inputs to a steering wheel and/or adjust vehicle steering sensitivity. Such active steering systems can improve vehicle control and/or vehicle handling during normal vehicle use.

A steering system (e.g., an active steering system, a power-assisted steering (PAS) system, an electric power-assisted steering (EPAS) system, etc.) can encounter steering kickback when a car is driving on rough road surfaces. In particular, when a front vehicle wheel engages a bump or pothole, torque can be transmitted from a road wheel to a steering wheel which, in turn, can cause sudden and potentially unexpected movement of the steering wheel.

### SUMMARY

An example apparatus includes a vehicle controller configured to control a torque of a motor operatively coupled to a steering wheel based on detected driver input. The vehicle controller is also configured to adjust the torque of the motor to vary an amount of steering kickback transferred to the steering wheel.

An example method includes controlling a torque of a motor operatively coupled to a steering wheel based on detected driver input. The example method also includes adjusting the torque of the motor to vary an amount of steering kickback transferred to the steering wheel.

An example tangible machine-readable medium includes instructions, which when executed, cause a processor to at least control a torque of a motor operatively coupled to a steering wheel based on detected driver input. The instructions also cause the processor to adjust a torque of a motor to vary an amount of steering kickback transferred to the steering wheel.

### BRIEF DESCRIPTION OF THE DRAWINGS

FIG. 1 is a view of an example vehicle in which examples disclosed may be implemented.

FIG. 2 is a schematic overview of an example steering system of the example vehicle of FIG. 1.

FIG. 3 is an exploded view of an example steering wheel assembly of the example steering system of FIG. 2.

FIG. 4 is a detailed view of a portion of the example steering wheel assembly of FIG. 3.

FIG. 5A illustrates example steering kickback monitoring that may be implemented in examples disclosed herein.

FIGS. 5B and 5C are detailed views depicting analysis of road grade or contours that can be implemented in examples disclosed herein.

FIG. 6 is a block diagram of an example steering kickback adjustment system in accordance with the teachings of this disclosure.

FIG. 7 is flowchart representative of example machine readable instructions that may be executed to implement examples disclosed herein.

FIG. 8 is a graph representing example data associated with examples disclosed herein.

FIG. 9 is a block diagram of an example processing platform that may execute example machine-readable instructions to implement the machine-readable instructions of FIG. 7 and/or the example steering kickback adjustment system of FIG. 6.

The figures are not to scale. Wherever possible, the same reference numbers will be used throughout the drawings and accompanying written descriptions to refer to the same or like parts.

### DETAILED DESCRIPTION

Apparatus and methods to adjust for steering kickback are disclosed. Some known steering systems (e.g., PAS systems, EPAS systems, etc.) assist a driver in steering a vehicle by reducing steering effort required to turn road wheels. Additionally, some other known steering systems (e.g., active steering systems) assist a driver in steering a vehicle by controlling an apparent gear or steering ratio between a steering column and road wheels, which may improve vehicle handling and/or vehicle maneuverability at different driving speeds. For example, a known active steering system may adjust steering sensitivity between a steering column and a steering wheel based on a speed of the vehicle.

However, the aforementioned known steering systems can sometimes transfer sudden steering movements (e.g., resulting from a road or objects on the road) from the steering column to the steering wheel, which is sometimes referred to as steering kickback. For example, the steering column may receive a steering kickback torque in response to a front wheel of the vehicle contacting an object and/or engaging a rough surface (e.g., sand, dirt, potholes, etc.). Such steering kickback can cause rapid and/or sudden movement(s) of the steering wheel, thereby making control of the steering wheel difficult and/or potentially reducing driver control.

Examples disclosed herein reduce and/or eliminate steering kickback by varying a degree to which the steering kickback is translated to a steering wheel. Examples disclosed herein provide an example controller (e.g., an electronic control unit (ECU)) to control a steering system (e.g., an active or adaptive steering system) of a vehicle. In particular, the example controller directs a steering motor (e.g., a motor associated with an active steering system) to counteract and/or vary a steering kickback torque that would have otherwise been transferred to a steering wheel.

In some examples, the example controller limits and/or reduces power provided to the motor when a steering kickback torque is detected. In such examples, a steering column drives and/or changes a position of the motor via a gear system operatively coupled between the motor, the steering wheel, and road wheels, thereby reducing and/or eliminating the steering kickback torque. In this manner, the controller enables back-drive of the motor during a detected or determined steering kickback event in some examples. As a result, at least a portion of the steering kickback torque transferred through the steering column is mitigated (e.g., absorbed by the motor). Thus, examples disclosed herein can prevent a driver from experiencing rapid and/or sudden movement(s) of the steering wheel when steering kickback is encountered.

In some examples, the controller enables back-drive of the motor for a relatively short time interval (e.g., 10 milliseconds, 100 milliseconds, 1 second, etc.) based on one or more settings associated with angular and/or torque control. In such examples, when a steering angle of the steering wheel deviates from a steering angle of the steering column and/or front wheels of the vehicle during the time interval resulting from the steering kickback event, the motor absorbs at least a portion of the steering kickback torque.

In some examples, the example controller adjusts a torque of the motor in response to determining that a sensor of the vehicle indicates steering kickback is likely to occur. In some disclosed examples, the controller communicates with one or more angular position sensors and/or torque sensors of the steering system to detect steering kickback torque. In other examples, the controller communicates with one or more acceleration sensors (e.g., an accelerometer) and/or ride height sensors (e.g., associated with a continuously controlled damping (CCD) system) to detect an impact indicative of steering kickback torque.

In some examples, the controller communicates with one or more optical sensors (e.g., one or more cameras) of the vehicle to monitor a driving surface (e.g., asphalt, concrete, sand, dirt, etc.) of a road and/or objects on the road to determine and/or predict a steering kickback condition for which an adjustment is needed. In such examples, the controller detects a condition or variation (e.g., a pothole, a bump, a hill, a grade, etc.) of the driving surface and/or a presence of an object (e.g., debris, trees, rocks, etc.) of the driving surface at a distance from the vehicle and determines whether the condition and/or the object is/are likely to cause steering kickback torque. In some examples, the controller can account for position(s) of the condition and/or the object relative to the vehicle, predicted paths of the vehicle wheels, calculated grades or slopes of the driving surface, and/or predicted times to engage the road condition or the object (e.g., a time associated with vehicle velocity).

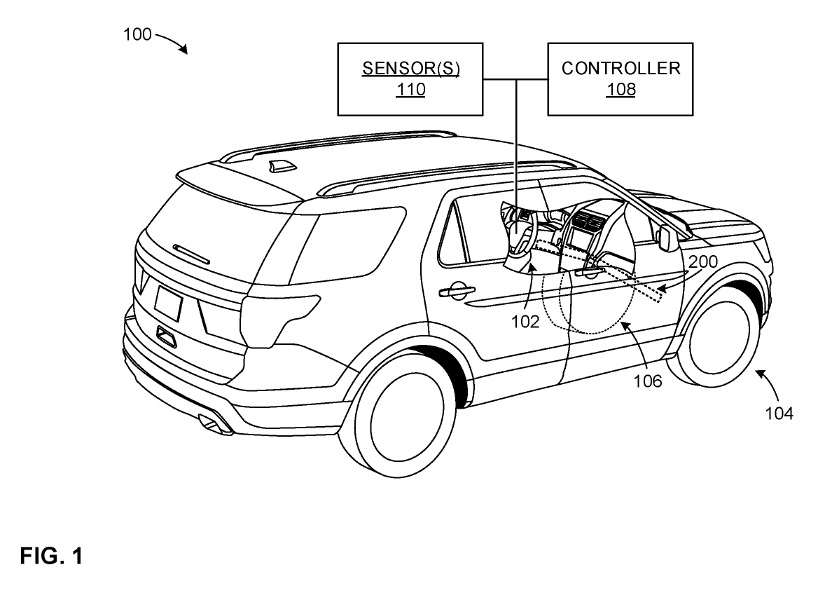

FIG. 1 is a view of an example vehicle (e.g., a car, a truck, a sport utility vehicle (SUV), etc.) 100 in which examples disclosed may be implemented. The example vehicle 100 of FIG. 1 includes an example steering wheel 102, road wheels 104, 106, an example vehicle controller 108, and one or more example sensors 110.

To implement steering control of the road wheels 104, 106, the example steering wheel 102 of FIG. 1 receives user input when a driver of the vehicle 100 rotates the steering wheel 102 to cause the road wheels 104, 106 of the vehicle 100 to rotate. While the example of FIG. 1 depicts the example vehicle 100 as having front wheel steering functionality, in other examples, the vehicle 100 may be implemented with all-wheel steering functionality, or any other appropriate type of steering implementation.

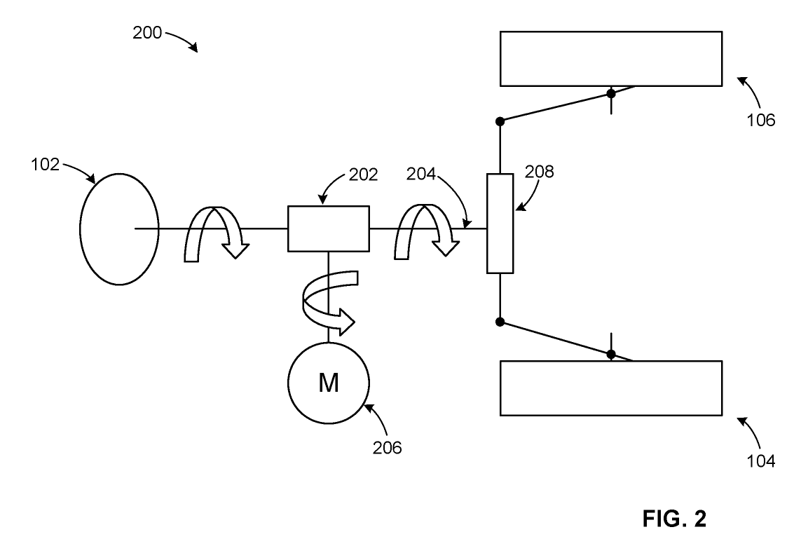

According to the illustrated example of FIG. 1, the controller 108 is communicatively coupled to the sensor(s) 110 and an example steering system 200 (shown in FIG. 2) of the vehicle 100. The example controller 108 at least partially controls steering of the vehicle 100 based on driver input provided to the steering wheel 102. In particular, when a driver rotates the steering wheel 102 and a corresponding steering angle is detected, the controller 108 directs the steering system 200 to vary a steering angle of the road wheels 104, 106.

As will be discussed in greater detail below in connection with FIGS. 2-9, examples disclosed herein can detect a steering kickback torque and/or a steering kickback event via the sensor(s) 110. In some examples, the sensor(s) 110 can include, but are not limited to, one or more of a force sensor, a ride height sensor (e.g., associated with a continuously controlled damping (CCD) system), and/or an acceleration sensor (e.g., accelerometer) to detect an impact and/or a force imparted on the road wheels 104, 106. Additionally or alternatively, the sensor(s) 110 includes one or more torque sensors and/or angular position sensors to detect one or more parameters (e.g., a torque, an angular position, an angular velocity, an angular acceleration, etc.) associated with the example steering wheel 102 and/or a steering column 204 (shown in FIG. 2). In some examples, the sensor(s) 110 include one or more optical sensors (e.g., cameras) to monitor a driving surface and predict a likelihood of contact with an object.

FIG. 2 is a schematic overview of the aforementioned example steering system (e.g., an active steering system) 200. According to the illustrated example of FIG. 2, the steering system 200 includes a gear system (e.g., a worm gear drive, a planetary gear drive, etc.) 202 operatively interposed between the steering wheel 102, the steering column 204, and a motor (e.g., an electric motor) 206. In particular, the example gear system 202 transmits a torque to the steering column 204 based on a torque received from the steering wheel 102 and a torque received from the motor 206. That is, in some examples, the gear system 202 and the motor 206 together operatively couple the steering wheel 102 to the steering column 204 and/or the road wheels 104, 106.

According to the illustrated example of FIG. 2, the motor 206 provides a torque to the gear system 202, thereby defining an apparent gear or steering ratio and/or adjusting a torque transferred between the example steering wheel 102 and the steering column 204. Stated differently, the example gear system 202 can vary a relationship between rotations of the steering wheel 102 and rotations of the steering column 204 and/or the road wheels 104, 106 based on the torque of the motor 206.

The steering column 204 of FIG. 2 is operatively coupled to the example vehicle wheels road 104, 106, for example, via another gear system (e.g., a rack and pinion system) 208, such that the road wheels 104, 106 rotate along with the steering column 204. In some examples, the example gear system 208 is implemented with one or more of a motor (e.g., an electric motor), an actuator, etc. (e.g., associated with a PAS system and/or an EPAS system) to provide additional torque to the road wheels 104, 106, thereby reducing the driver effort required to rotate the road wheels 104, 106.

In response to a control signal received from the above disclosed controller 108, the torque of the motor 206 is adjusted to adjust the amount of driver steering input (e.g., rotations of the steering wheel 102) to turn the road wheels 104, 106. In some examples, the example steering system 200 reduces steering sensitivity or the steering ratio between the steering wheel 102 and the steering column 204 and/or the road wheels 104, 106 at high vehicle speeds (e.g., via reducing the torque of the motor 206). Conversely, in some examples, the steering system 200 also increases steering sensitivity or the steering ratio between the steering wheel 102 and the steering column 204 and/or the road wheels 104, 106 at low vehicle speeds (e.g., via increasing the torque of the motor 206).

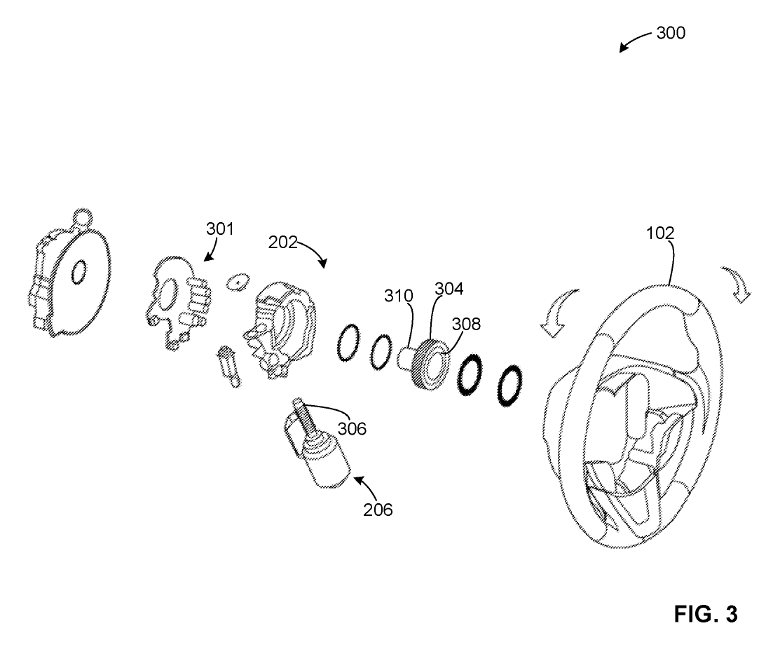

FIG. 3 is an exploded view of an example steering wheel assembly 300. The steering wheel assembly 300 of FIG. 3 includes the aforementioned steering wheel 102, the motor 206, and an example electronic control unit (ECU) 301, which is positioned in the steering wheel 102 in this example. According to the illustrated example of FIG. 3, the ECU 301 is to be communicatively coupled to the motor 206 to control torque thereof.

According to the illustrated example of FIG. 3, the steering wheel assembly 300 also includes the gear system 202, which is depicted as a worm gear drive assembly in this example. The example gear system 202 of FIG. 3 includes a first example gear (e.g., a helical gear, a spur gear, etc.) 304 that is operatively coupled with a second example gear (e.g., a worm gear) 306. The example first gear 304 is rotatably coupled to the steering wheel 102 via a hub or bearing 308 and coupled to the steering column 204 via a shaft 310. In particular, the gear system 202 of FIG. 3 increases torque provided from the motor 206 to the steering column 204 and/or the road wheels 104, 106. For example, the motor 206 applies a first torque to the second gear 306 and, in response, the second gear 306 applies a second torque, which is greater than the first torque, to the first gear 304.

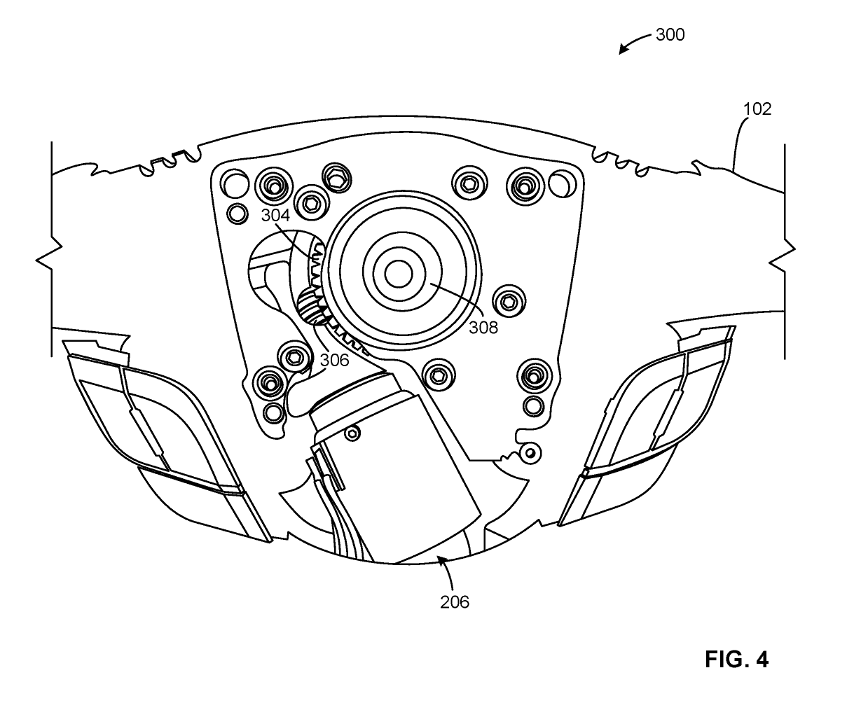

FIG. 4 is a detailed view of a portion of the example steering wheel assembly 300 of FIG. 3. In the illustrated example of FIG. 4, the first gear 304 is disposed (e.g., centrally disposed) in the steering wheel 102 and rotatably coupled thereto via the bearing 308. Further, the motor 206 is fixedly coupled to the steering wheel 102 proximate to the first gear 304 in this example such that teeth of the second gear 306 are engaged with teeth of the first gear 304.

According to the illustrated example, the steering wheel 102 is rotatably coupled to the steering column 204 via the gear system 202 and the motor 206. In particular, torque that is transferred between the steering wheel 102 and the steering column 204 and/or the road wheels 104, 106 is based on a torque applied to the first gear 304 by the motor 206.

While the example of FIG. 4 depicts the motor 206, the first gear 304, the second gear 306, and the bearing 308 positioned in the example steering wheel 102, in other examples, one or more of the motor 206, the first gear 304, the second gear 306, and/or the hub or bearing 308 may be positioned in different locations (e.g., external relative to the steering wheel 102). Further, in some examples, the gear system 202 may be implemented differently. For example, the gear system 202 includes a differential gear assembly (e.g., a planetary gear drive, a strain wave or harmonic gear drive, etc.) operatively interposed between the steering wheel 102, the steering column 204, and the motor 206 to similarly control torque transferred therebetween.

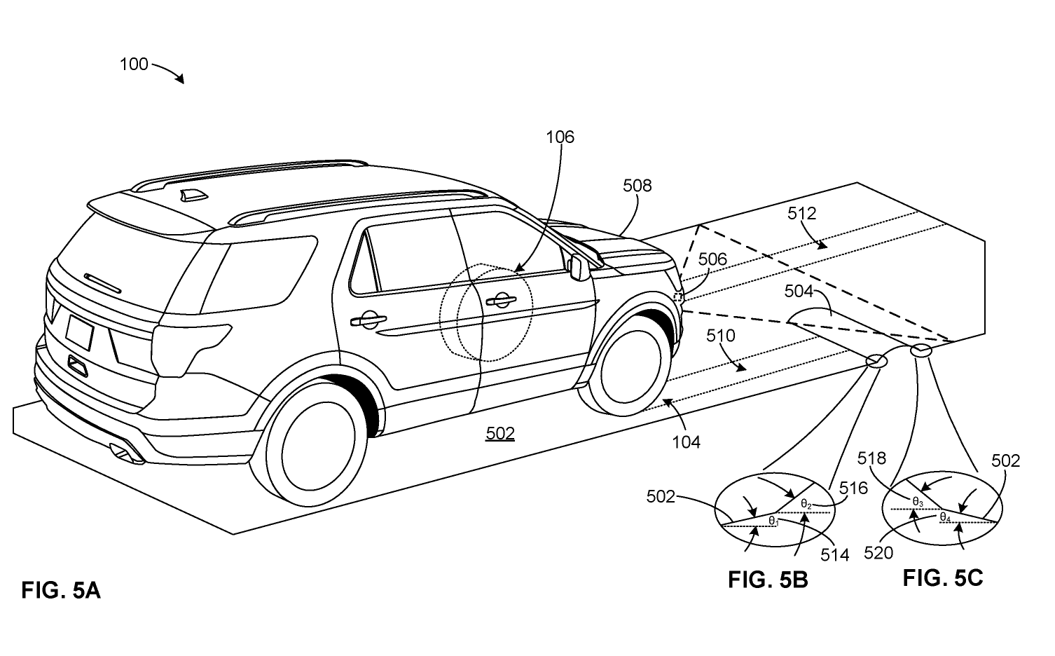

FIG. 5A illustrates example steering kickback monitoring that may be implemented in examples disclosed herein. In the illustrated example of FIG. 5A, the example vehicle 100 of FIG. 1 is moving along an example driving surface 502 (e.g., a sand, dirt, asphalt, concrete, etc. surface). As previously mentioned, a steering kickback event may be caused by conditions or variations (e.g., a bump or protrusion, a pothole or recess, a particular grade or slope, etc.), contours, and/or objects (e.g., debris, trees, rocks, etc.) associated with the driving surface 502. For example, when at least one road wheel 104, 106 (e.g., the front right wheel 104) of the vehicle 100 engages an example protrusion 504 of the driving surface 502, a steering kickback torque may be transmitted to the steering wheel 102 of the vehicle 100.

In the illustrated example of FIG. 5A, to monitor potential steering kickback that can result from the driving surface 502, the vehicle 100 includes at least one optical sensor (e.g., a camera) 506 to monitor the surface 502 and generate corresponding data. In this example, the example optical sensor 506 is disposed on a front end 508 of the vehicle 100 and faces toward the surface 502. In other examples, the optical sensor 506 may be positioned on a different portion of the vehicle 100.

In some examples, wheel paths of the road wheels 104, 106 are taken into account. In such examples, the first road wheel 104 of the vehicle 100 is associated with a first wheel path 510 (represented by the dotted/dashed lines of FIG. 5A) that indicates a trajectory of the first road wheel 104 as a function of time as the vehicle 100 moves. Similarly, the second wheel 106 of the vehicle 100 can be associated with a second wheel path 512 (represented by the dotted/dashed lines of FIG. 5A), which indicates a trajectory of the second wheel 106 as a function of time as the vehicle 100 moves.

In some examples, road contours are monitored for potential situations that may result in steering kickback. In such examples, the driving surface 502 includes a contour having different grades or slopes. As shown in the illustrated example of FIG. 5B, the driving surface 502 has a first grade (e.g., a 10% grade) 514 and a second grade (e.g., a 20% grade) 516, both of which are positive grades in this example.

Turning to FIG. 5C, in some examples, the driving surface 502 has a third grade (e.g., a −25% grade) 518 and a fourth grade (e.g., a −15% grade) 520, both of which are negative grades in this example. The values disclosed herein are examples for illustrative purposes and other values may apply in other examples.

While the example of FIG. 5A depicts the driving surface 502 as only having the protrusion 504, in other examples, the driving surface 502 may include one or more other road conditions associated with steering kickback, such as potholes, bumps, etc. Further, in some examples, the driving surface 502 may include one or more objects associated with causing steering kickback, such as road debris, trees, rocks, etc.

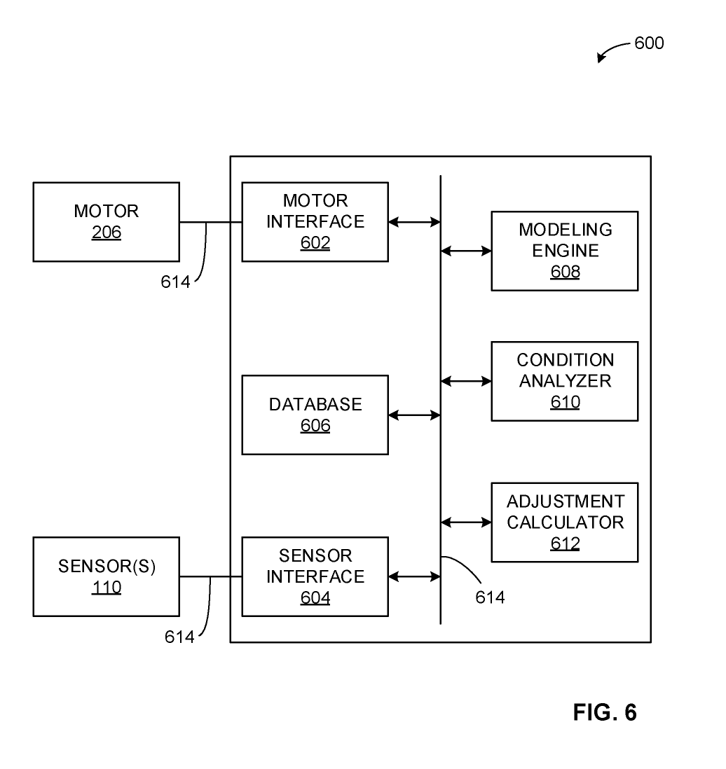

FIG. 6 is a block diagram of an example steering kickback adjustment system 600 in accordance with the teachings of this disclosure. The example steering kickback adjustment system 600 of FIG. 6 can be implemented by the example controller 108 of FIG. 1 and/or the example ECU 301 of FIGS. 3 and 4. The example steering kickback adjustment system 600 of FIG. 6 includes a motor interface 602, a sensor interface 604, a database 606, a modeling engine 608, a condition analyzer 610, and an adjustment calculator 612. In the example of FIG. 6, the vehicle steering kickback adjustment system 600 is communicatively coupled to the sensor(s) 110 disclosed above in connection with FIG. 1 and the example motor 206 disclosed above in connection with FIGS. 2-4 via communication link(s) 614 such as, for example, one or more signal transmission wires or busses, radio frequency, etc. In particular, the example motor interface 602 provides command signals and/or power to the motor 206 to enable the motor 206 to generate torque.

To mitigate or reduce steering kickback encountered by a driver, the example steering kickback adjustment system 600 directs the motor 206 to control torque transferred between the steering wheel 102 and the steering column 204. In particular, the steering kickback adjustment system 600 of the illustrated example adjusts a torque of the motor 206 applied to the gear system 202 to counteract and/or vary a steering kickback torque associated with the steering column 204, as discussed in greater detail below.

The example motor interface 602 controls (e.g., reduces and/or limits) power provided to the motor 206, which enables the motor 206 to reduce or mitigate at least a portion of the steering kickback torque associated with the steering column 204 and/or the road wheels 104, 106. For example, the steering kickback torque is transmitted to the motor 206 from the steering column 204 via the gear system 202, thereby driving and/or changing a position of the motor 206 while leaving the steering wheel 102 substantially unaffected by the steering kickback torque. In some examples, the motor interface 602 enables back-drive of the motor 206 for a relatively short time interval (e.g., 10 milliseconds, 100 milliseconds, 1 second, etc.) to provide and/or permit angular deviation between the steering wheel 102 and the steering column 204.

In the illustrated example of FIG. 6, the sensor interface 604 is communicatively coupled to the one or more example sensors 110 via the communication link(s) 614 to receive data therefrom. In some examples, the sensor(s) 110 provide a detected torque, a detected angular position, a detected change in the angular position (e.g., an angular velocity, an angular acceleration, etc.) of the steering wheel 102 and/or the steering column 204 to the sensor interface 604.

In some examples, the sensor(s) 110 provide data associated with a driving surface (e.g., concrete, asphalt, dirt, sand, etc.) to the sensor interface 604, which may indicate potential steering kickback. In some such examples, the sensor(s) 110 provide data associated with and/or indicating a variation (e.g., a bump or protrusion, a pothole or recess, a grade or slope, etc.), a contour, and/or an object (e.g., debris, trees, rocks, etc.) of the driving surface 502. Additionally or alternatively, in some examples, the sensor(s) 110 provide a detected force associated with the road wheel(s) 104, 106.

To determine a degree to which the steering kickback adjustment system 600 adjusts for steering kickback, the condition analyzer 610 analyzes data received from one or more of the sensor interface 604, the database 606, and/or the modeling engine 608. In particular, the condition analyzer 610 determines whether one or more conditions associated with the vehicle 100 indicate steering kickback. If at least one of the condition(s) is determined or predicted, the condition analyzer 610 enables the adjustment calculator 612 to calculate and/or determine one or more adjustments for the motor 206 to reduce or mitigate the steering kickback.

In some examples, the condition analyzer 610 determines whether at least one of the road wheel(s) 104, 106 of the vehicle 100 will be caused to move (e.g., jerk) based on the aforementioned wheel paths 510, 512, the position of the protrusion 504 (and/or one or more other variations, contours, and/or objects), and/or time(s) until impact. In particular, the condition analyzer 610 can compare the wheel paths 510, 512 to the position of the protrusion 504 to determine whether at least one of the wheel paths 510, 512 will engage the protrusion 504. For example, in response to at least one of the wheel paths 510, 512 intersecting the position of the protrusion 504, the condition analyzer 610 determines steering kickback will occur and/or when steering kickback is predicted.

In some examples, the condition analyzer 610 may determine whether a single road wheel 104, 106 is and/or will be impacted. For example, the condition analyzer 610 determines that the protrusion 504 will engage the first road wheel 104 based on the first wheel path 510 intersecting the position of the protrusion 504, but will not engage the second wheel 106 of the vehicle 100 based on the second wheel path 512 not intersecting the position of the protrusion 504.

In some examples, the condition analyzer 610 determines whether a vehicle driving mode (e.g., an off-road driving mode) is active or enabled, which may indicate that steering kickback is likely to occur and/or correlates to an increased amount of steering kickback. In some examples, the condition analyzer 610 determines whether the one or more settings of the vehicle 100 are active or enabled associated with providing and/or permitting angular deviation between the steering wheel 102 and the steering column 204.

In some examples, the condition analyzer 610 may compare grades or slopes of a driving surface to determine whether at least one grade satisfies a first grade threshold (e.g., 5%, 10%, 20%, etc.) and/or a second grade threshold (e.g., −5%, −10%, −20%, etc.), which can indicate steering kickback. For example, the condition analyzer 610 compares one or more of the grades 514, 516, 518, 520 shown in FIGS. 5B and 5C to the first grade threshold and/or the second grade threshold.

In the example of FIG. 6, the example adjustment calculator 612 performs one or more calculations associated with controlling the example motor 206. As such, in some examples, the adjustment calculator 612 transmits (e.g., via the wired and/or wireless communication link(s) 614) computed data to the database 606. In particular, the example adjustment calculator 612 calculates and/or determines an adjustment of torque applied to the gear system 202 by the motor 206 to counteract and/or vary an amount of steering kickback associated with the steering column 204. In some examples, the adjustment includes increasing or decreasing a torque generated by the motor 206. In some examples, the adjustment includes keeping or maintaining (e.g., limiting) the torque of the motor 206.

In this example, the adjustment calculator 612 calculates and/or determines the adjustment of torque based on one or more of a detected parameter of the steering wheel 102, a detected parameter of the steering column 204, a degree of steering kickback (e.g., predicted by the modeling engine 608 and/or detected via the sensor(s) 110), and/or a detected speed of the vehicle 100.

In some examples, the adjustment of torque is based on the one or more settings stored in the database 606 associated with torque and/or angular control and/or angular deviation between the steering wheel 102 and the steering column 204. In such examples, the adjustment of torque enables angular deviation between the steering wheel 102 and the steering column 204 for a time interval based on the one or more settings. For example, a rate of rotation of the steering wheel 102 increases or decreases (e.g., via back-driving the motor 206) relative to a rate of rotation of the steering column 204 during the time interval.

After determining the adjustment of torque, the adjustment calculator 612 transmits (e.g., via the wired and/or wireless communication link(s) 614) the adjustment to the motor interface 602 to control the motor 206 accordingly. In particular, the example motor interface 602 adjusts a torque generated by the motor 206 in accordance with the calculated adjustment to counteract and/or vary an amount of steering kickback.

The database 606 of the illustrated example stores and/or provides access to data associated with the example vehicle 100 of FIG. 1, the example steering system 200 of FIG. 2, the example steering wheel assembly 300 of FIGS. 3 and 4, and/or the example steering kickback adjustment system 600. For example, the example database 606 receives data from and/or transmits data to (e.g., via the wired and/or wireless communication link(s) 614) one or more of the motor interface 602, the sensor interface 604, the modeling engine 608, the condition analyzer 610, and/or the adjustment calculator 612. Additionally or alternatively, the database 606 stores road conditions and/or sensor data.

In some examples, the database 606 stores one or more settings associated with a vehicle driving mode, such as an off-road driving mode, a comfort driving mode, etc. In some examples, the database 606 stores one or more settings associated with angular and/or torque control between the steering wheel 102 and the steering column 204, such as permitted angular deviation between the steering wheel 102 and the steering column 204 and/or the road wheels 104, 106 during a steering kickback event.

In some examples, the example modeling engine 608 of FIG. 6 performs one or more calculations associated with detecting steering kickback and/or predicting steering kickback based on data received from the sensor(s) 110, thereby enabling the condition analyzer 610 to determine whether to adjust a torque of the motor 206. In particular, the modeling engine 608 identifies one or more conditions associated with the vehicle 100 that may be indicative of steering kickback. Further, in some examples, the example modeling engine 608 of FIG. 6 detects and/or predicts a degree of a steering kickback torque associated with the steering column 204 based on data received from the sensor(s) 110, which can better enable the adjustment calculator 612 to calculate and/or determine an adjustment for the motor 206. As such, in some examples, the modeling engine 608 transmits (e.g., via the wired and/or wireless communication link(s) 614) computed data to the database 606, the condition analyzer 610, and/or the adjustment calculator 612. Further, in such examples, the modeling engine 608 performs calculations in accordance with one or more equations, models, algorithms, methods, and/or techniques (e.g., stored in the database 606) related to detecting steering kickback and/or predicting steering kickback.

In some examples, the modeling engine 608 identifies and/or detects a variation (e.g., a bump or protrusion, a pothole or recess, a grade or slope, etc.), a contour, and/or an object (e.g., road debris, trees, rocks, etc.) of a driving surface based on data received from the sensor(s) 110. For example, the modeling engine 608 calculates and/or determines a position of the protrusion 504 shown in FIG. 5A relative to the first road wheel 104 and/or the second wheel 106 of the vehicle 100. In some such examples, the modeling engine 608 calculates a distance between the protrusion 504 shown in FIG. 5A and the road wheel(s) 104, 106 of the vehicle 100 and, based on the distance and/or a speed of the vehicle 100, calculates a time associated with when the road wheel(s) 104,106 is/are to reach and/or engage the protrusion 504. Further, in such examples, the modeling engine 608 predicts a degree of steering kickback associated with the protrusion 504, for example, based on a calculated size, shape, and/or geometry of the protrusion 504.

In some examples, the modeling engine 608 calculates one or more grades or slopes of the driving surface 502 to similarly predict steering kickback and/or a degree of steering kickback. For example, the modeling engine 608 calculates and/or determines one or more of the grades 514, 516, 518, 520 of the driving surface 502 shown in FIGS. 5B and 5C. In such examples, the modeling engine 608 compares one or more of the grades 514, 516, 518, 520 to the first grade threshold and/or the second grade threshold.

Additionally or alternatively, the modeling engine 608 calculates and/or predicts one or more vehicle wheel paths to determine whether and/or which of the road wheel(s) 104, 106 will encounter steering kickback. For example, the modeling engine 608 calculates the first wheel path 510 shown in FIG. 5A associated with the first road wheel 104 of the vehicle 100 and/or the second wheel path 512 associated with the second wheel 106.

In some examples, the modeling engine 608 determines a type of driving surface (e.g., concrete, asphalt, sand, dirt, etc.) based on data received from the sensor(s) 110. For example, the modeling engine 608 determines that the driving surface 502 is dirt. In such examples, the modeling engine 608 predicts when the vehicle 100 is to encounter a new and/or a rough driving surface.

While an example manner of implementing the steering kickback adjustment system 600 is illustrated in FIG. 6, one or more of the elements, processes and/or devices illustrated in FIG. 6 may be combined, divided, re-arranged, omitted, eliminated and/or implemented in any other way. Further, the example motor interface 602, the sensor interface 604, the database 606, the modeling engine 608, the condition analyzer 610, the adjustment calculator 612, and/or, more generally, the example steering kickback adjustment system 600 of FIG. 6 may be implemented by hardware, software, firmware and/or any combination of hardware, software and/or firmware. Thus, for example, any of the example motor interface 602, the sensor interface 604, the database 606, the modeling engine 608, the condition analyzer 610, the adjustment calculator 612, and/or, more generally, the example steering kickback adjustment system 600 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example motor interface 602, the sensor interface 604, the database 606, the modeling engine 608, the condition analyzer 610, the adjustment calculator 612, and/or, more generally, the example steering kickback adjustment system 600 is/are hereby expressly defined to include a non-transitory computer readable storage device or storage disk such as a memory, a digital versatile disk (DVD), a compact disk (CD), a Blu-ray disk, etc. including the software and/or firmware. Further still, the example steering kickback adjustment system 600 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

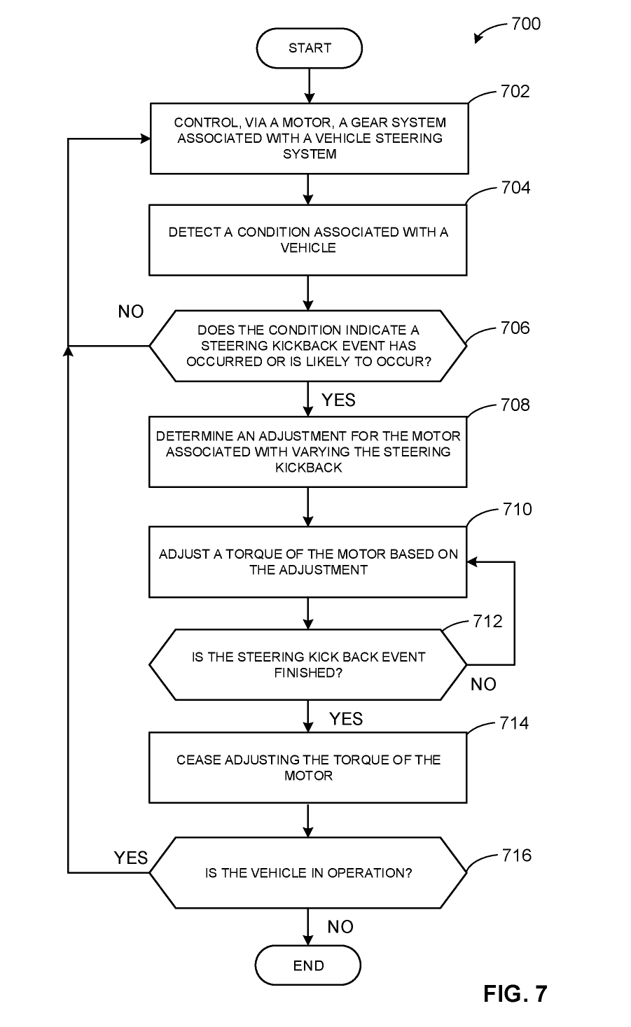

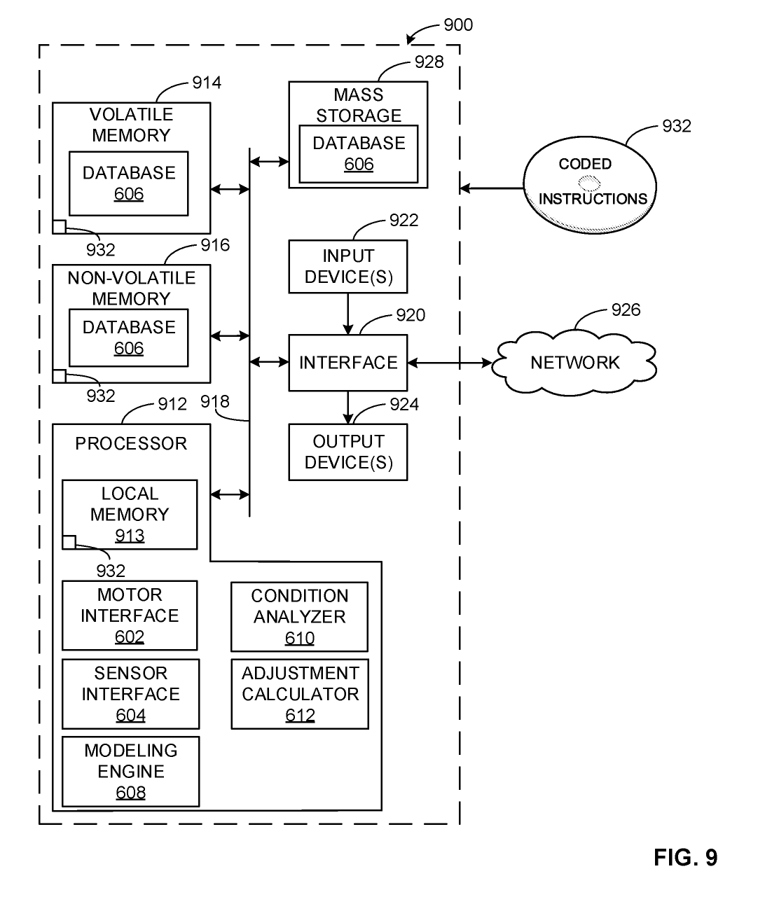

A flowchart representative of example hardware logic or machine readable instructions for implementing the example steering kickback adjustment system 600 of FIG. 6 is shown in FIG. 7. The machine readable instructions may be a program or portion of a program for execution by a processor such as the processor 912 shown in the example processor platform 900 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 7, many other methods of implementing the example steering kickback adjustment system 600 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

FIG. 7 illustrates a flowchart representative of example machine-readable instructions that may be executed to implement an example method 700 to reduce and/or eliminate steering kickback. The example method 700 can be implemented in any of the example vehicle 100 of FIG. 1, the example steering system 200 of FIG. 2, the example steering wheel assembly 300 of FIGS. 3 and 4, and/or the example steering kickback adjustment system 600 of FIG. 6.

The example method 700 of FIG. 7 begins by controlling, via a motor, a gear system associated with a vehicle steering system (block 702). In some examples, the steering kickback adjustment system 600 of FIG. 6 controls the gear system 202 via the example motor 206. In particular, the example steering kickback adjustment system 600 communicates with the motor 206 to generate a torque and apply the torque to the gear system 202, which can define an apparent gear or steering ratio between the steering wheel 102 and the steering column 204.

In some examples, the steering kickback adjustment system 600 controls the motor 206 based on sensor data such as, for example, one or more detected parameters (e.g., an angular position, an angular velocity, an angular acceleration, a torque, etc.) of the steering wheel 102 and/or the steering column 204. In some examples, based on a first detected angle of the steering wheel 102, the steering kickback adjustment system 600 controls the motor 206 such that the steering column 204 and/or the example road wheels 104, 106 rotate to a second steering angle corresponding to the first steering angle (e.g., with substantially no angular deviation between the steering wheel 102 and the steering column 204).

Additionally or alternatively, the steering kickback adjustment system 600 controls the motor 206 based on a speed of the vehicle 100. In such examples, the steering kickback adjustment system 600 controls the motor 206 such that a steering angle to turn the road wheels 104, 106 decreases at relatively high vehicle speeds and/or increases at relatively low vehicles speeds.

The example method 700 of FIG. 7 also includes detecting a condition associated with a vehicle (block 704). In some examples, the steering kickback adjustment system 600 of FIG. 6 detects (e.g., via the modeling engine 608 and/or the condition analyzer 610) one or more conditions associated with the example vehicle 100. In particular, the condition(s) are used to indicate whether steering kickback is occurring or will occur.

The example method 700 of FIG. 7 also includes determining whether the condition indicates a steering kickback event has occurred or is likely to occur (block 706). In particular, the steering kickback adjustment system 600 of FIG. 6 analyzes (e.g., via the modeling engine 608 and/or the condition analyzer 610) the condition(s) associated with the example vehicle 100 at block 704 to determine whether steering kickback is occurring or will occur.

If the steering kickback adjustment system 600 of FIG. 6 determines that none of the detected condition(s) associated with the vehicle 100 indicates steering kickback (block 706), control of the process returns to block 704. Otherwise, if the steering kickback adjustment system 600 determines that at least one of the detected condition(s) associated with the vehicle indicates steering kickback (block 706), control of the process proceeds to block 708.

The example method 700 of FIG. 7 also includes determining an adjustment for the motor associated with varying the steering kickback (block 708). In some examples, the steering kickback adjustment system 600 calculates and/or determines (e.g., via the adjustment calculator 612) an adjustment of torque for the motor 206. In particular, the adjustment of torque results in a reduced or mitigated steering kickback torque associated with the steering column 204.

The example method 700 of FIG. 7 also includes adjusting a torque of the motor based on the adjustment (block 710). In some examples, the steering kickback adjustment system 600 of FIG. 6 controls (e.g., via the motor interface 602) the example motor 206 based on the adjustment determined at block 708. In particular, the example steering kickback adjustment 600 system increases, decreases, or maintains (e.g., limits) the torque generated by the motor 206 in accordance with the adjustment to counteract and/or vary the steering kickback torque associated with the steering column 204.

In some examples, the example steering kickback adjustment system 600 reduces and/or limits the power provided to the motor 206, which enables the steering column 204 to drive and/or change a position of the motor 206. That is, the motor 206 absorbs at least a portion of the steering kickback torque applied to the gear system 202 by the steering column 204 that would have otherwise been transmitted to the steering wheel 102. In this manner, the example steering kickback adjustment system 600 reduces or mitigates the steering kickback torque associated with the steering system 200.

In some examples, the steering kickback adjustment system 600 controls the motor 206 to enable back-drive of the motor 206 for a time interval (e.g., a predetermined time interval) based on the one or more settings associated with torque and/or angular control between the steering wheel 102 and the steering column 204. In such examples, the steering angle of the steering wheel 102 deviates from the steering angle of the steering column 204 during the time interval via back-driving the motor 206, thereby preventing the steering kickback torque from being transmitted to the steering wheel 102.

The example method 700 of FIG. 7 also includes determining whether the steering kickback event is finished (block 712). In some examples, the steering kickback adjustment system 600 of FIG. 6 determines (e.g., via the modeling engine 608 and/or the condition analyzer 610) whether the steering kickback event associated with the example vehicle 100 is finished or complete. In some examples, if the steering kickback adjustment system 600 determines that the steering kickback event is finished or complete, control of the example method 700 proceeds to block 714. Otherwise, in some examples, if the steering kickback adjustment system 600 determines that the steering kickback event is not finished or complete, control of the example method 700 returns to block 710.

The example method 700 of FIG. 7 also includes ceasing adjusting the torque of the motor (block 714). In some examples, the steering kickback adjustment system 600 of FIG. 6 ceases adjusting (e.g., via the motor interface 602) the torque of the motor 206 in connection with the adjustment determined at block 708.

The example method 700 of FIG. 7 also includes determining whether the vehicle is in operation (block 716). In some examples, if the steering kickback adjustment system 600 of FIG. 6 determines that the vehicle 100 is in operation, control of the example method 700 returns to block 702. Otherwise, in some examples, if the steering kickback adjustment system 600 determines that the vehicle 100 is not in operation, the process ends.

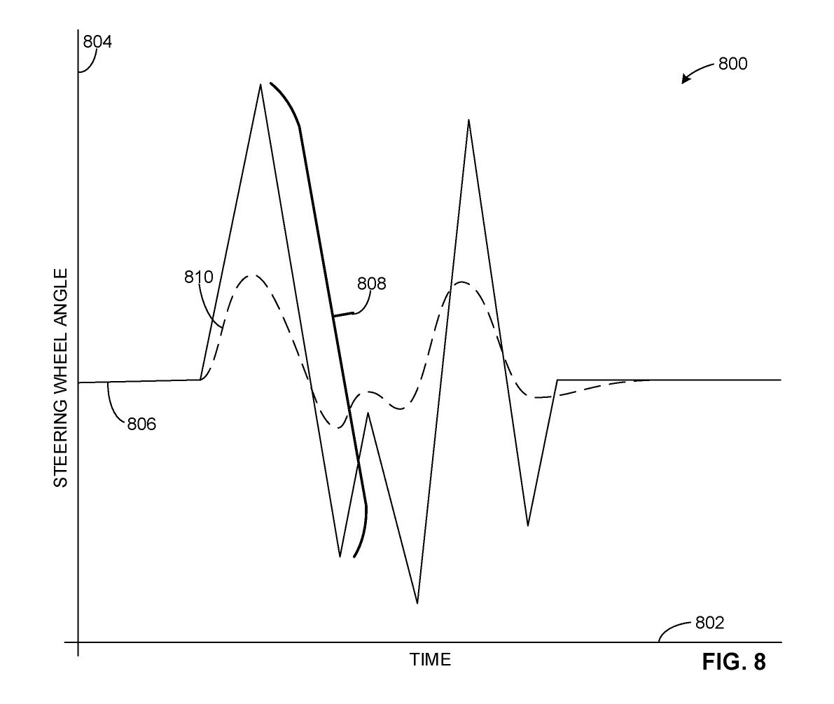

FIG. 8 is a graph 800 representing example steering data associated with an example vehicle steering system. The graph 800 of FIG. 8 includes a horizontal axis 802 that corresponds to time and a vertical axis 804 that represents angular positions of a steering wheel.

According to the illustrated example, a first plot 806 characterizes movement of the steering wheel associated with steering kickback during vehicle operations and/or maneuvers. As shown in FIG. 8, a first portion 808 of the first plot has a relatively large amplitude corresponding to a steering kickback event and/or a steering kickback torque transmitted to the steering wheel. In contrast, a second plot 810 similarly characterizes movement of the steering wheel at a reduced and/or mitigated steering kickback based on examples disclosed herein.

FIG. 9 is a block diagram of an example processor platform 900 structured to execute the instructions of FIG. 7 to implement the example steering kickback adjustment system 600 of FIG. 6. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example motor interface 602, the sensor interface 604, the modeling engine 608, the condition analyzer 610, and/or the adjustment calculator 612.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

The machine executable instructions 932 of FIG. 7 may be stored in the mass storage device 928, in the volatile memory 914, in the non-volatile memory 916, and/or on a removable non-transitory computer readable storage medium such as a CD or DVD.

From the foregoing, it will be appreciated that example systems and methods have been disclosed that control steering of a vehicle to at least partially reduce and/or eliminate steering kickback.

Although certain example apparatus and methods have been disclosed herein, the scope of coverage of this patent is not limited thereto. On the contrary, this patent covers all apparatus and methods fairly falling within the scope of the claims of this patent.

What is claimed is:

1. An apparatus comprising:
a vehicle controller configured to:
control a torque of a motor that is operatively coupled to a steering wheel based on detected driver input; and
adjust the torque of the motor to vary an amount of steering kickback transferred to the steering wheel.

2. The apparatus of claim 1, wherein the controller is to:
determine that the steering kickback has occurred or will occur; and
adjust the torque of the motor in response to the determination.

3. The apparatus of claim 2, wherein the controller is configured to predict, via a sensor, a degree of the steering kickback, wherein the torque of the motor is adjusted based on the degree of the steering kickback.

4. The apparatus of claim 3, wherein the sensor includes a camera, the camera to detect a condition of or an object on a driving surface that indicates steering kickback.

5. The apparatus of claim 4, wherein the condition of the driving surface includes a grade, wherein the controller is configured to compare the grade to a threshold grade, and wherein the torque of the motor is adjusted in based on the comparison.

6. The apparatus of claim 3, wherein the sensor includes at least one of an accelerometer or a ride height sensor, the accelerometer or the ride height sensor to detect a vehicle impact.

7. The apparatus of claim 2, wherein the controller is configured to determine whether a vehicle driving mode is enabled that correlates to steering kickback, and wherein the torque of the motor is adjusted in response to the vehicle driving mode being enabled.

8. The apparatus of claim 1, wherein adjusting the torque of the motor includes reducing or limiting power provided to the motor.

9. The apparatus of claim 1, wherein adjusting the torque of the motor enables a steering column to drive the motor.

10. The apparatus of claim 1, wherein adjusting the torque of the motor includes increasing or decreasing angular deviation between the steering wheel and road wheels for a time interval.

11. A method comprising:
controlling a torque of a motor that is operatively coupled to a steering wheel based on detected driver input; and
adjusting the torque of the motor to vary an amount of steering kickback transferred to the steering wheel.

12. The method of claim 11, further including:
determining that the steering kickback has occurred or will occur; and
adjusting the torque of the motor in response to the determination.

13. The method of claim 12, further including predicting, via a sensor, a degree of the steering kickback, and wherein the torque of the motor is adjusted based on the degree of the steering kickback.

14. The method of claim 13, wherein the sensor includes a camera, the camera to detect a condition of or an object on a driving surface, wherein the condition or the object indicates steering kickback.

15. The method of claim 14, further including comparing a parameter of the variation to a threshold, wherein the torque of the motor is adjusted in based on the comparison.

16. The method of claim 11, wherein adjusting the torque of the motor includes reducing or limiting power provided to the motor.

17. A tangible machine-readable storage medium comprising instructions which, when executed, cause a processor to at least:
control a torque of a motor operatively coupled to a steering wheel based on driver input; and
adjust the torque of the motor to vary an amount of steering kickback transferred to the steering wheel.

18. The tangible machine-readable medium of claim 17, wherein the instructions cause the processor to:
determine that the steering kickback has occurred or will occur; and
adjust the torque of the motor in response to the determination.

19. The tangible machine-readable medium of claim 18, wherein the instructions cause the processor to predict, via a sensor, a degree of the steering kickback, wherein the torque of the motor is adjusted based on the degree of the steering kickback.

20. The tangible machine-readable medium of claim 19, wherein the sensor includes a camera, the camera to detect a condition of or an object on a driving surface.

21. The tangible machine-readable medium of claim 17, wherein the instructions cause the processor to determine whether a vehicle driving mode is enabled that correlates to steering kickback, wherein the torque of the motor is adjusted in response to the vehicle driving mode being enabled.

22. The tangible machine-readable medium of claim 17, wherein adjusting the torque of the motor enables a steering column to drive the motor.

23. The tangible machine-readable medium of claim 17, wherein adjusting the torque of the motor provides angular deviation between the steering wheel and road wheels for a time interval.
